(19) United States
(12) Patent Application Publication
(10) Pub. No.: US 2026/0332717 A1
(43) Pub. Date: Oct. 22, 2026

(54) IMAGE FORMING DEVICE, IMAGE FORMING METHOD, AND RECORDING MEDIUM

(71) Applicants: Kazuhiko Kikuchi, Kanagawa (JP); Kiyotaka Murakami, Sunto Shizuoka (JP); Norio Tanaka, Numazu Shizuoka (JP); Toshiyuki Ueno, Sunto Shizuoka (JP); Kiyoshi Iwaki, Mishima Shizuoka (JP); Taku Fujinami, Sunto Shizuoka (JP)

(72) Inventors: Kazuhiko Kikuchi, Kanagawa (JP); Kiyotaka Murakami, Sunto Shizuoka (JP); Norio Tanaka, Numazu Shizuoka (JP); Toshiyuki Ueno, Sunto Shizuoka (JP); Kiyoshi Iwaki, Mishima Shizuoka (JP); Taku Fujinami, Sunto Shizuoka (JP)

(73) Assignee: ETRIA CO., LTD., Kanagawa (JP)

(21) Appl. No.: 19/284,668

(22) Filed: Jul. 29, 2025

(30) Foreign Application Priority Data
Apr. 21, 2025 (JP) 2025-069541

(51) Int. Cl. H04N 1/32; G06K 17/00

(52) U.S. Cl. CPC H04N 1/32138; G06K 17/0025

(57) ABSTRACT

An image forming device includes an image former configured to form an image on a sheet having a plurality of radio tags, a tag communicator configured to perform a write process of data to the radio tags, and a controller configured to perform image formation on the sheet when no error has occurred in the write process. The controller performs a write process related to data in which the error has occurred to another sheet. When a plurality of data items are sequentially processed, if there is a space in a radio tag on a target sheet of a final write process and there is write data erroneous in the write process on a sheet before the target sheet, the controller executes the write process for the target sheet by including a part or all of the erroneous data in a processing target.

### CROSS-REFERENCE TO RELATED APPLICATION

This application is based upon and claims the benefit of priority from Japanese Patent Application No. 2025-069541, filed Apr. 21, 2025, the entire content of which is incorporated herein by reference.

### FIELD

The present embodiments relate to an image forming device, an image forming method, and a recording medium.

### BACKGROUND

An image forming device can simultaneously perform a process for writing information to a radio frequency identification (RFID) tag (hereinafter, sometimes simply referred to as a tag or a radio tag) with respect to special paper with the RFID tag and a process for forming an image on the paper. For such an image forming device, technology for performing read and write processes on the tag before an image is formed on the special paper and retrying the processes on other special paper without forming an image on the special paper when an error occurs during the read and write processes (retry printing) has been proposed.

However, when special multi-tag paper (hereinafter simply referred to as paper) having a plurality of tags in single special paper is processed, overall processing efficiency may deteriorate due to errors in some tags in conventional retry printing.

### BRIEF DESCRIPTION OF THE DRAWINGS

FIG. 1 is a cross-sectional view showing an example of a configuration of an image forming device 10 according to the present embodiment.

FIG. 2 is a diagram showing an example of a hardware configuration of the image forming device 10 according to the present embodiment.

FIG. 3 is a diagram showing an example of a position of a sheet S in the image forming device 10 of the present embodiment.

FIG. 4 is a diagram showing an example of a configuration of the sheet S in the present embodiment.

FIG. 5 is a diagram showing an example of an ID stored in a radio tag in an initial state.

FIG. 6 is a diagram showing an example of print data supplied from an external device such as a PC for an image forming process on the sheet S.

FIG. 7 is an explanatory diagram (part 1) of an overview of the image forming process performed on the sheet S.

FIG. 8 is an explanatory diagram (part 2) of the overview of the image forming process performed on the sheet S.

FIG. 9 is an explanatory diagram (part 3) of the overview of the image forming process performed on the sheet S.

FIG. 10 is a flowchart showing an example of a flow of the image forming process performed on the sheet S by the image forming device 10 of the present embodiment.

FIG. 11 is a diagram showing an example of a print data group of a processing target.

FIG. 12 is a diagram showing an example of a result of processing a print data group by the image forming device 10 of the present embodiment.

### DETAILED DESCRIPTION

According to the present embodiment, there is provided an image forming device including: an image former configured to form an image on a radio tag sheet that is a sheet having a plurality of radio tags; a tag communicator configured to perform a write process of write data to the radio tags; and a controller configured to perform image formation according to the write data in a target area according to the radio tag on the radio tag sheet in a case where no error has occurred in the write process. In a case where an error has occurred in the write process, the controller performs a write process related to write data in which the error has occurred to another radio tag sheet different from the radio tag sheet, and in a case where a plurality of write data items are sequentially processed, if there is a space in a radio tag on a target sheet, which is a radio tag sheet on which a final write process is performed, and there is write data erroneous in the write process on a radio tag sheet before the target sheet, the controller executes the write process for the target sheet by including a part or all of the erroneous write data in a processing target.

When special paper for multi-tag having a plurality of RFID tags is processed, the image forming device according to the present embodiment can suppress the deterioration in overall processing efficiency caused by a defective RFID tag.

Hereinafter, an image forming device and a radio tag communication device according to embodiments will be described with reference to the drawings. As used throughout the present disclosure, the singular forms “a,” “an,” and “the” include plural references unless the context clearly dictates otherwise.

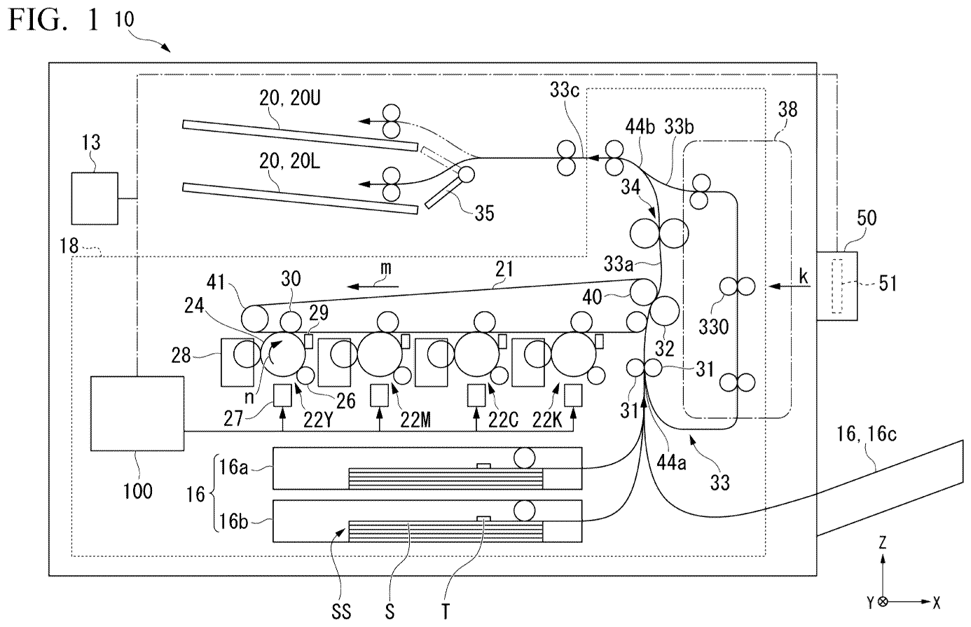

First, the configuration of an image forming device 10 according to an embodiment will be described with reference to FIG. 1. FIG. 1 is a cross-sectional view showing an example of the configuration of the image forming device 10 according to the present embodiment. For example, the image forming device 10 is placed in a workplace. Hereinafter, a medium on which the image forming device 10 forms an image is referred to as a sheet. The sheet is typically a paper medium, but may be any medium having a material and shape that can be a target of an image formation process of a printer 18 to be described below.

In FIG. 1, the image forming device 10 has a control panel 13, a radio tag communication device 50, and a printer 18. The printer 18 includes a controller 100, paper feed cassettes 16a and 16b, and the like. The controller 100 controls a control panel 13, a radio tag communication device 50, and a printer 18. The controller 100 controls the conveyance of a sheet in the printer 18. Sheet conveyance control means the control of a sheet conveyance timing, a sheet stopping position, a sheet conveyance speed, or the like.

The control panel 13 includes input keys and a display. For example, the input keys receive inputs from a user. For example, the display is of a touch panel type. The display receives the input from the user and displays the received input to the user. For example, the control panel 13 displays items related to the operation of the image forming device 10 on the display so that the items can be set. The control panel 13 notifies the controller 100 of the items set by the user.

The paper feed cassettes 16a and 16b store radio tag sheets (hereinafter simply referred to as “sheets”) S having radio tags T. In addition, the paper feed cassettes 16a and 16b can store sheets S that do not have any radio tags T. In the following description, unless otherwise specified, the sheets S are sheets S having radio tags T. For example, the sheets S are made of a material such as paper or a plastic film.

The printer 18 performs an operation for forming an image. For example, the printer 18 forms an image indicated in image data on a sheet. In the following description, forming the image on the sheet is also referred to as “printing.” In addition, in the present embodiment, the printer 18 is a device that fixes a toner image, but is not limited thereto and may be an inkjet type device.

The printer 18 includes an intermediate transfer belt 21. The printer 18 supports the intermediate transfer belt 21 with a driven roller 41, a backup roller 40, and the like. The printer 18 rotates the intermediate transfer belt 21 in a direction of an arrow m. The printer 18 includes four sets of image forming stations 22Y, 22M, 22C, and 22K. The image forming stations 22Y, 22M, 22C, and 22K correspond to Y (yellow), M (magenta), C (cyan), and K (black), respectively. The image forming stations 22Y, 22M, 22C, and 22K are arranged below the intermediate transfer belt 21 in a rotation direction of the intermediate transfer belt 21.

The image forming station 22Y (yellow) will be described below as an example among the image forming stations 22Y, 22M, 22C, and 22K. In addition, because the image forming stations 22M, 22C, and 22K have configurations similar to that of the image forming station 22Y, detailed description thereof will be omitted.

The image forming station 22Y includes an electrostatic charger 26, an exposure scanning head 27, a developing device 28, and a photoconductor cleaner 29. The electrostatic charger 26, the exposure scanning head 27, the developing device 28, and the photoconductor cleaner 29 are arranged around the photoconductor drum 24 that rotates in a direction of an arrow n.

The image forming station 22Y includes a primary transfer roller 30. The primary transfer roller 30 is arranged facing the photoconductor drum 24 via the intermediate transfer belt 21.

The electrostatic charger 26 uniformly charges the photoconductor drum 24. The exposure scanning head 27 exposes the uniformly charged photoconductor drum 24 to light and forms an electrostatic latent image on the photoconductor drum 24. The developing device 28 develops the electrostatic latent image on the photoconductor drum 24 using a two-component developer formed of toner and carrier.

The primary transfer roller 30 primarily transfers the toner image formed on the photoconductor drum 24 onto the intermediate transfer belt 21. Primary transfer rollers 30 of the image forming stations 22Y, 22M, 22C, and 22K primarily transfer the toner image onto the intermediate transfer belt 21, thereby forming a color toner image on the intermediate transfer belt 21. The color toner image is a toner image formed by sequentially overlapping toner images of Y (yellow), M (magenta), C (cyan), and K (black). The photoconductor cleaner 29 removes toner remaining on the photoconductor drum 24 after the primary transfer.

The printer 18 includes a secondary transfer roller 32. The secondary transfer roller 32 is arranged facing the backup roller 40 via the intermediate transfer belt 21. The secondary transfer roller 32 secondarily transfers the color toner images on the intermediate transfer belt 21 onto the sheet all at once. The secondary transfer roller 32 functions as an image former that forms an image on the sheet. In the following description, it is assumed that the term “toner image” may be either a color toner image or a toner image of only a single color. Moreover, the toner image may be a toner image using a decolorizing toner.

The conveyance path 33 is a path along which a sheet is conveyed by a plurality of conveyance rollers (e.g., conveyance rollers 330 or the like). The conveyance path 33 includes a first conveyance path 33a, a second conveyance path 33b, and a third conveyance path 33c. The first conveyance path 33a is a conveyance path from a merger 44a to a brancher 44b. The second conveyance path 33b is a conveyance path that passes through the inside of a double-sided printing device 38, and is a conveyance path from the brancher 44b to the merger 44a different from the first conveyance path 33a. The third conveyance path 33c is a conveyance path from the brancher 44b to a paper output tray 20.

The sheet S is taken out from the sheet placer 16 of any one of a paper feed cassette 16a, a paper feed cassette 16b, and a manual feed tray 16c. A sheet set SS including a plurality of sheets S is arranged on a sheet placer 16. Registration rollers 31 are located on an upstream side of the secondary transfer roller 32 in the conveyance direction of the sheet S in the first conveyance path 33a. The sheet S taken out from the sheet placer 16 is temporarily stopped at a portion where two stopped registration rollers 31 are in contact with each other. At this time, a leading edge of the sheet S is abutted against the registration rollers 31 and an inclination of the sheet S is corrected. The controller 100 starts the rotation of the registration rollers 31 in accordance with the position of the toner image on the rotating intermediate transfer belt 21 and moves the sheet S to the position of the secondary transfer roller 32.

The toner image formed on the intermediate transfer belt 21 is secondarily transferred to a sheet by the secondary transfer roller 32. Furthermore, the secondarily transferred toner image is fixed to the sheet by a fixing device 34. In this way, an image is formed on the sheet under the control of the controller 100. The controller 100 conveys the sheet on which the toner image has been fixed by the fixing device 34 to the third conveyance path 33c and discharges the sheet onto the paper output tray 20.

The paper output tray 20 has an upper tray 20U and a lower tray 20L. A distribution mechanism 35 is located on the upstream side of the paper output tray 20 in the sheet conveyance direction. The distribution mechanism 35 switches the sheet discharge destination between the upper tray 20U and the lower tray 20L.

The radio tag communication device 50 includes a calculation device, a storage device, and an antenna 51. The radio tag in the present embodiment is, for example, a radio frequency identifier (RFID) tag. The radio tag communication device 50 transmits radio waves, for example, in a direction of an arrow k. The radio tag communication device 50 communicates with the radio tag T provided on the sheet S via the antenna 51. For example, the radio tag communication device 50 can wirelessly communicate with the radio tag T of the sheet S temporarily stopped by the registration rollers 31 located on the first conveyance path 33a. Specifically, the radio tag communication device 50 reads information from the radio tag T and writes information to the radio tag T.

The information written to the radio tag is an identification number of the sheet or the like. For example, when the sheet is used for logistics or the like, information indicating contents, information indicating a destination, content to be printed on the sheet, and the like may be written to the radio tag. In the present embodiment, the radio tag communication device 50 uses, for example, a radio wave scheme (UHF) in a 900 MHz band. However, an RFID scheme and a frequency band are not limited to these and other schemes and other frequency bands can also be adopted.

The controller 100 controls parts of the image forming device 10. The radio tag communication device 50 may be configured separately from the image forming device 10 as shown in FIG. 1 or may be integrally configured as a part of the image forming device 10.

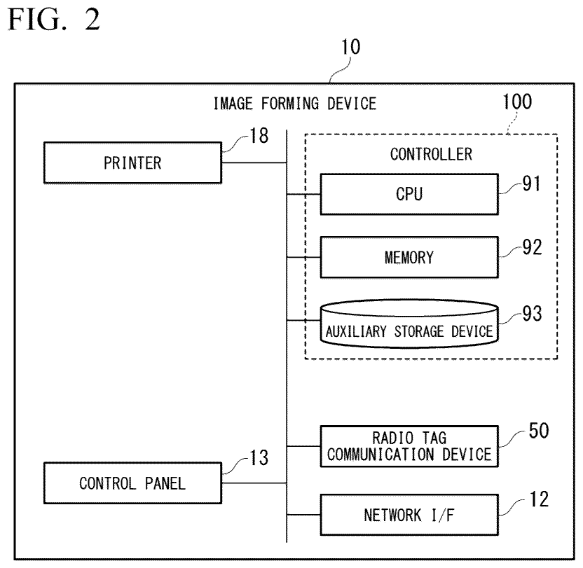

FIG. 2 shows an example of a hardware configuration of the image forming device 10 of the present embodiment. The image forming device 10 includes a central processing unit (CPU) 91, a memory 92, an auxiliary storage device 93, and the like, which are connected via a bus, and executes a program. The image forming device 10 functions as a device including a printer 18, a control panel 13, a network interface 12, and a radio tag communication device 50 by executing the program.

The CPU 91 executes programs stored in the memory 92 and the auxiliary storage device 93 to function as a controller 100. The controller 100 controls an operation of each functional part of the image forming device 10.

The auxiliary storage device 93 is configured using a storage device such as a magnetic hard disk device or a semiconductor storage device. The auxiliary storage device 93 stores information.

The network interface 12 is a communication interface for connecting the image forming device 10 to a communication network. The network interface 12 may be a wireless communication interface or a wired communication interface. The network interface 12 may be a LAN interface or a cellular communication interface. The image forming device 10 is capable of communicating with other devices via the network interface 12.

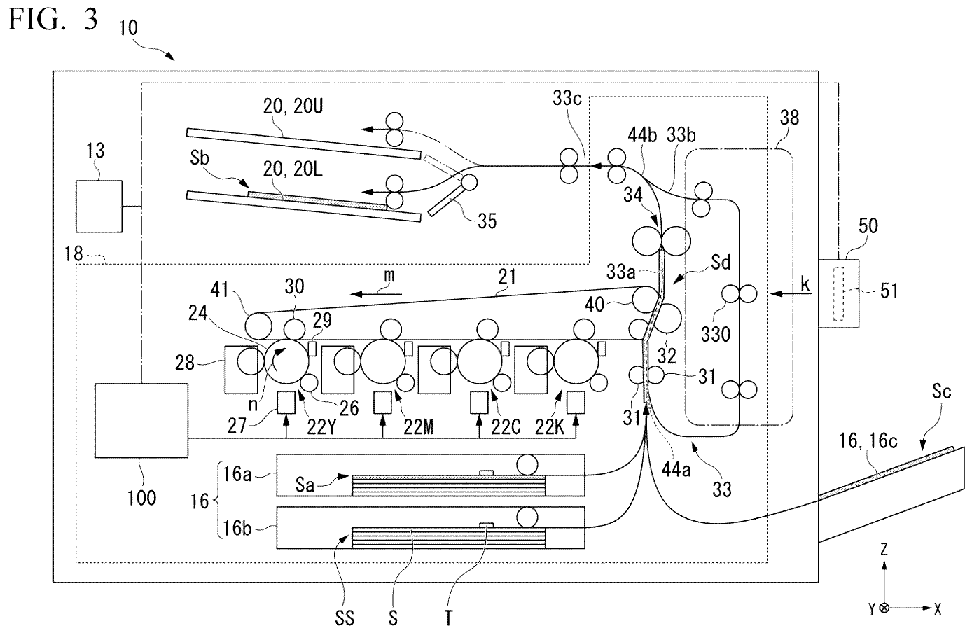

FIG. 3 shows an example of a position of a sheet S in the image forming device 10 of the present embodiment. In FIG. 3, a sheet Sa is a sheet S placed in the paper feed cassette 16a. A sheet Sb is a sheet S placed in the paper output tray 20. A sheet Sc is a sheet placed in the manual feed tray 16c. A sheet Sd is a sheet S that is being conveyed through the conveyance path 33a. In the present embodiment, information is written to the radio tag of sheet S when the sheet S is in the state of the sheet Sd. Hereinafter, a position of the sheet Sd on the conveyance path 33a will be referred to as a writable position of the radio tag.

In a state shown in FIG. 3, the radio tag communication device 50 transmits radio waves in the direction of the arrow k. The radio tag of the sheet Sd, which has received the radio waves, transmits radio waves back to the radio tag communication device 50. The radio tag communication device 50 receives radio waves from the radio tag provided on the sheet Sd.

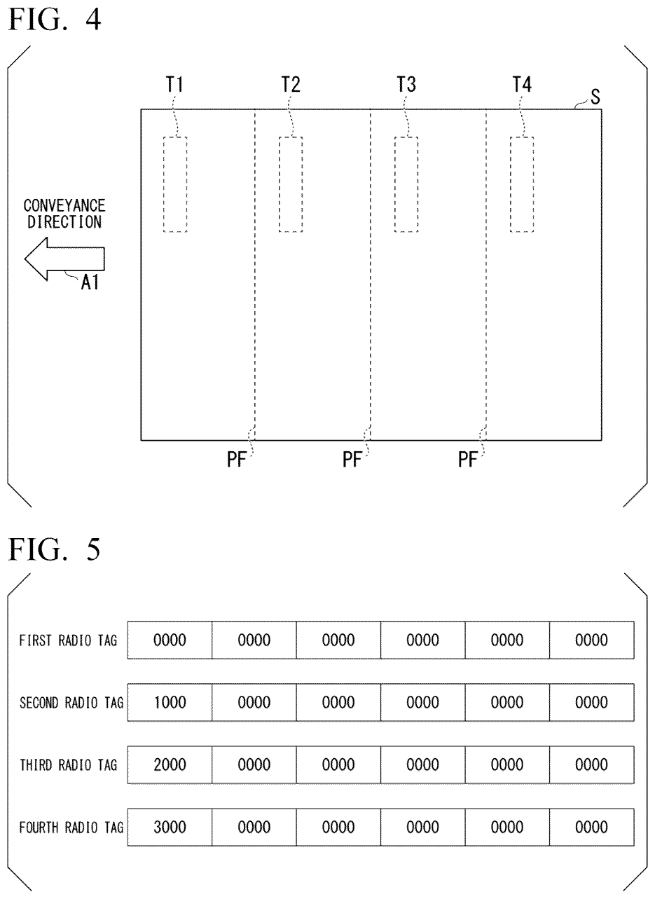

FIG. 4 shows an example of the configuration of the sheet S in the present embodiment. The sheet S in the present embodiment has three equally spaced perforations PF so that it can be separated into three sub-sheets S1 to S4 having equal widths. A direction of an arrow A1 is a conveyance direction of the sheet S. The sheet S shown in FIG. 4 has four radio tags provided from the left end to the right end of the sheet so that one radio tag is arranged on each sub-sheet. These four radio tags are referred to as a radio tag T1, a radio tag T2, a radio tag T3, and a radio tag T4 in order from the left end, and their IDs are referred to as a T1 tag ID, a T2 tag ID, a T3 tag ID, and a T4 tag ID.

The radio tag has a storage that stores an ID. The radio tag can provide the ID stored in the storage to another device having a radio tag reader function, such as the radio tag communication device 50. When the radio tag communication device 50 transmits radio waves in the direction of the arrow k (see FIG. 3), there is a possibility that a plurality of radio tags provided on the sheet S will respond. In other words, there is a possibility that a plurality of radio tags will provide their IDs, and the radio tag communication device 50 will acquire the IDs of the plurality of radio tags.

In the present embodiment, it is assumed that an ID is stored in advance in the radio tag in the initial state provided on the sheet S. The radio tag in the initial state here is a radio tag included in an unprocessed sheet S and is a radio tag before information is written by the radio tag communication device 50. The ID includes position information indicating the position of the tag on the sheet S. The position information conforms to a predetermined rule. The radio tag communication device 50 acquires the ID of the radio tag as the position information of the radio tag. Because the position information conforms to the predetermined rule, the radio tag communication device 50 can identify the position of the radio tag on the basis of the acquired position information. Thereby, even if the radio tag communication device 50 acquires IDs of a plurality of radio tags, it is possible to write information to the radio tag according to the position of the radio tag provided on the sheet. In addition, in the present embodiment, it is assumed that the radio tag is correctly installed at a position on the sheet S indicated by the ID.

FIG. 5 shows an example of an ID stored in a radio tag in an initial state. For example, the ID is stored in a user memory inside the radio tag. When there is no user memory, an EPC memory may be used. In the example of FIG. 5, the radio tag has six storage areas each having an amount of information of four decimal digits (for a total of 24 digits). FIG. 5 shows an example in which the highest 24^{th} digit of the 24 digits indicates position information. That is, the position information of a radio tag T1 (first radio tag) is “0,” the position information of a radio tag T2 (second radio tag) is “1,” the position information of the radio tag T3 (third radio tag) is “2,” and the position information of the radio tag T4 (fourth radio tag) is “3.” In this case, the radio tag communication device 50 can refer to the first digit of the ID acquired from the radio tag to recognize the radio tag from which the ID has been acquired and recognize the position of the radio tag on the sheet.

Therefore, for example, in the case of the sheet S of FIG. 4, the radio tag communication device 50 can write data for the radio tag T1 to the radio tag T1. The radio tag communication device 50 can write data for the radio tag T2 to the radio tag T2. The radio tag communication device 50 can write data for the radio tag T3 to the radio tag T3. The radio tag communication device 50 can write data for the radio tag T4 to the radio tag T4.

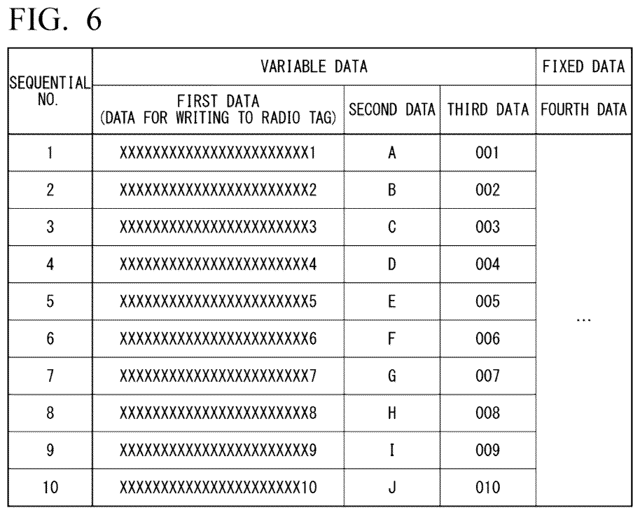

FIG. 6 shows an example of data (hereinafter referred to as “print data”) supplied from an external device such as a PC in relation to an image formation process on a sheet S. FIG. 6 shows an example of 10 print data items. Each print data item is managed to be identifiable by a sequential number and each print data item includes data for writing to a radio tag and data for printing on the sheet S. FIG. 6 shows an example in which first data, second data, and third data are provided as variable print data and fourth data is provided as fixed print data. For example, the fourth data may be data for printing a common frame between sub-sheets or the like. Moreover, FIG. 6 shows an example in which the first data of the variable print data is used as data for writing to a radio tag.

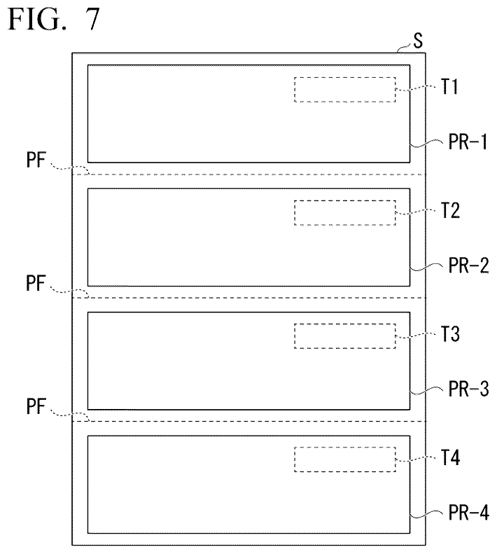

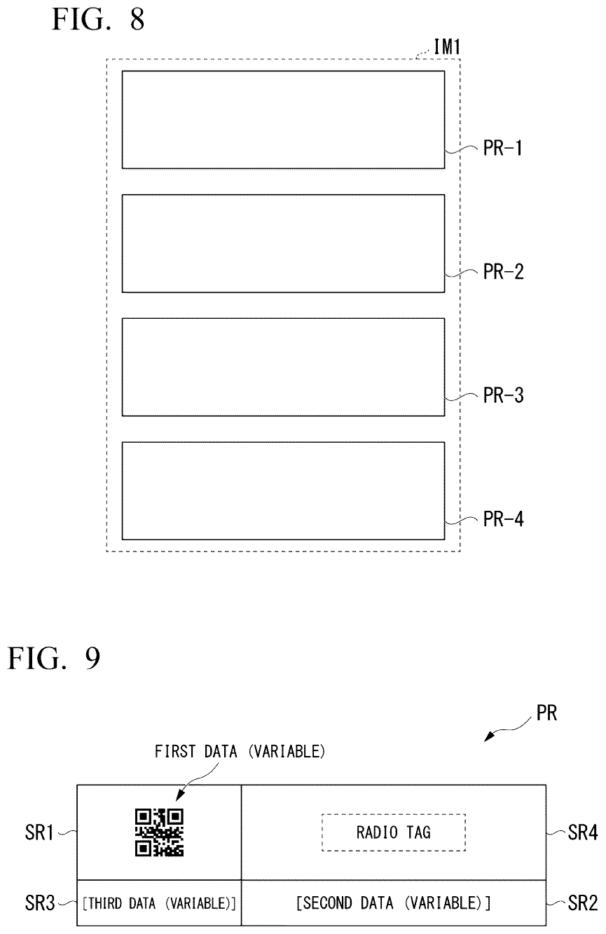

FIGS. 7 to 9 show an overview of the image forming process performed on the sheet S. Here, for simplicity, a case where all four radio tags provided on the sheet S are normal will be described. In FIG. 7, print areas PR-1 to PR-4 are areas where the content of the print data is printed on the sheet S and are areas corresponding to sub-sheets S1 to S4. That is, in the image forming process on the sheet S in the present embodiment, image data IM1 for image formation is generated on the basis of four print data items corresponding to the sub-sheets S1 to S4 (FIG. 8) and the image data IM1 is printed on the sheet S, such that the content linked to the corresponding radio tags T1 to T4 is printed in the print areas PR-1 to PR-4 (see FIG. 6).

FIG. 9 shows an example of the print area for each sub-sheet. For example, the print area PR for each sub-sheet is divided into first to third areas SR1 to SR3 in which first data (variable), second data (variable), and third data (variable) are printed, and a fourth area SR4 in which no printing is performed and which serves as a position for installing a radio tag. Moreover, for example, in the print area of the sub-sheet, the boundary between the first to fourth areas may be printed using fourth data (fixed).

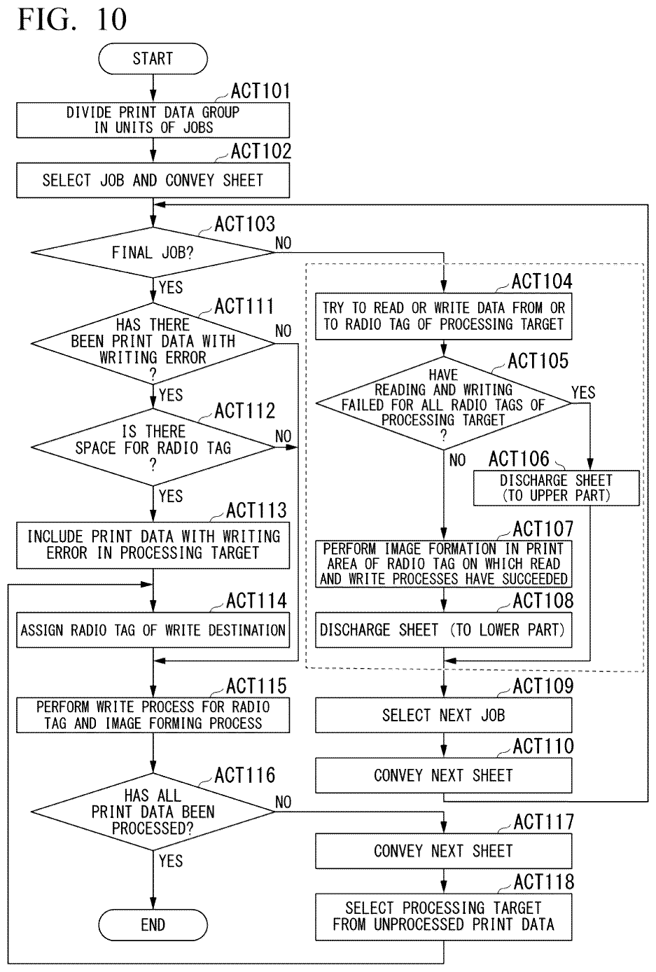

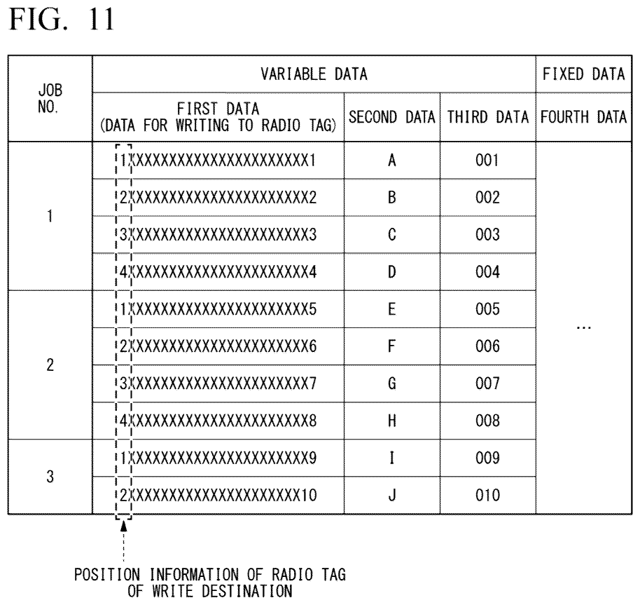

FIG. 10 is a flowchart showing an example of a flow of the image forming process performed on the sheet S by the image forming device 10 of the present embodiment. First, the image forming device 10 acquires a print data group for use in the image forming process on the sheet S from an external device such as a PC, and generates a job by dividing the acquired print data group into an estimated number of sheets (ACT101).

FIG. 11 shows an example of a print data group of a processing target. FIG. 11 shows an example in which 10 print data groups are acquired and three jobs are generated for each of four print data items. When jobs are generated, the image forming device 10 adds position information of the radio tag to be written for each print data item. FIG. 11 shows an example in which position information is added to the beginning of the first data. In the present embodiment, because four radio tags are provided on one sheet S, the 10 print data items are divided by four to generate three jobs.

Returning to FIG. 10, the image forming device 10 subsequently selects a first job and conveys the sheet S from the paper feed cassette 16a or 16b in the printer 18 to a position where the radio tag can be written (ACT102). Subsequently, the image forming device 10 determines whether or not the job selected in ACT102 is a final job (ACT103). Here, when the current job is not the final job, the image forming device 10 proceeds to the “NO” branch of ACT103, tries to read or write data from or to the radio tag (the processing target) of the sheet S conveyed in ACT102 (ACT104), and determines whether or not reading and writing have failed for all radio tags of the processing target (ACT105).

More specifically, the image forming device 10 tries to read the ID from the radio tag of the sheet S and determines which of the radio tags T1 to T4 is a transmission source of the ID on the basis of a received ID. Thereby, the image forming device 10 can recognize a position of a readable radio tag for the sheet S of a processing target. Here, when the IDs of all the radio tags cannot be read, the image forming device 10 proceeds to the “YES” branch of ACT105 and discharges the sheet S onto the upper tray 20U (ACT106).

Moreover, the image forming device 10 tries to write the first data to the radio tag whose ID has been successfully read and determines whether or not the write process has been successful. For example, in FIG. 11, when a print data group of job No. 1 is being processed and the read process on the radio tag T1 has been successful, the image forming device 10 tries to write the first data (data whose last digit is 1) whose leading data value is 1 among the four first data items (data whose last digit is 1 to 4) to the radio tag T1. When a result of trying similar write processes on the radio tags whose IDs have been successfully read indicates that all write processes have failed, the image forming device 10 proceeds to the “YES” branch of ACT105 and discharges the sheet S to the upper tray 20U (ACT106).

On the other hand, when reading and writing have succeeded for one or more radio tags, the image forming device 10 proceeds to the “NO” branch of ACT105 and performs image formation for the print area corresponding to the radio tag on the basis of the print data of the radio tag on which read and write processes have succeeded (ACT107). The image forming device 10 discharges the sheet S on which the image formation has been performed in ACT107 to the lower tray 20L (ACT108). Subsequently, the image forming device 10 selects the next job (ACT109), conveys the next sheet (ACT110), and returns the process to ACT103.

When the current job is the final job in ACT103, the image forming device 10 proceeds to the “YES” branch of ACT103 and determines whether or not there has been print data with a writing error (including a case where the radio tag cannot be read and writing is not performed) in a job before the current job (ACT111). Here, when there has been print data with a writing error, the image forming device 10 proceeds to the “YES” branch of ACT111 and determines whether or not there is a space in a radio tag for use in the sheet S of a processing target (ACT112).

For example, in the case of the print data group in the example of FIG. 11, because a job of job No. 3 is the final job and the number of print data items of the final job is two, two radio tags are free in the sheet S of the processing target. In this way, when there is a space in a radio tag on the sheet S of the processing target, the image forming device 10 proceeds to the “YES” branch of ACT112, and selects print data for the number of free radio tags from the print data with the writing error to include the selected print data in the processing target (ACT113). Subsequently, the image forming device 10 assigns a radio tag of a write destination to the print data of the processing target (ACT114). Subsequently, the image forming device 10 performs a write process for the radio tag and an image forming process for the sheet S on the basis of the assignment of the radio tag decided in ACT114 (ACT115). The processing of ACT115 is similar to the processing of ACT104 to ACT108 surrounded by a dashed line.

Subsequently, the image forming device 10 determines whether or not all print data has been processed (ACT116). Here, when there is no unprocessed print data, the image forming device 10 proceeds to the “YES” branch of ACT116 and ends the series of processing steps. On the other hand, when there is unprocessed print data in ACT116, the image forming device 10 proceeds to the “NO” branch of ACT116, conveys the next sheet (ACT117), selects a processing target from the unprocessed print data, and returns the process to ACT114 (ACT118).

On the other hand, when there is no print data having a writing error in ACT111 or when there is no space in a radio tag on the sheet S of the processing target in ACT112, the image forming device 10 skips ACT113 and ACT114 and moves the process to ACT115. In the case of NO of ACT111, because there is no print data erroneous in the job before the final job, all print data is processed if ACT115 for the final job ends normally, and the series of processing steps ends.

Moreover, in the case of NO of ACT112, a new sheet S is conveyed after the final job is completed (ACT117) and the erroneous print data is processed for the new sheet S (ACT115). Subsequently, when all print data that is erroneous has been processed, the series of processing steps ends.

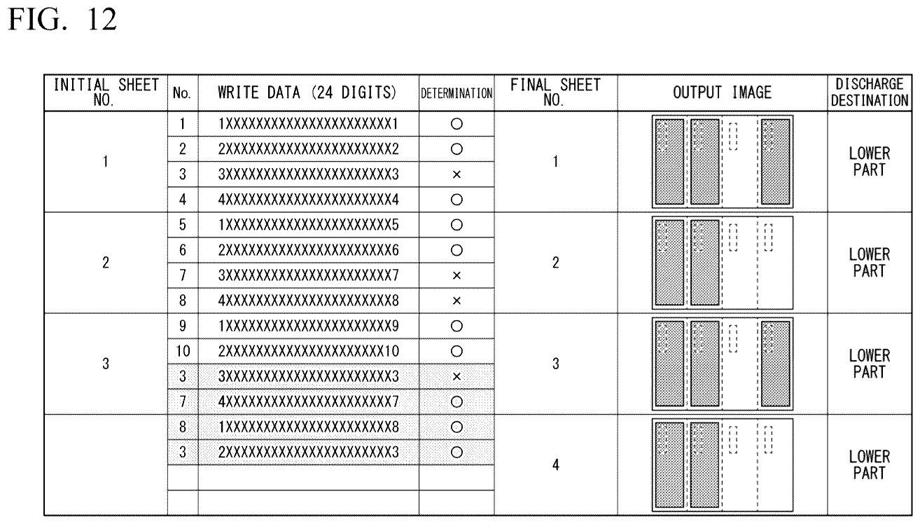

FIG. 12 shows an example of a result of processing a print data group by the image forming device 10 of the present embodiment. FIG. 12 is an example of the result of processing the print data group exemplified in FIG. 11. In FIG. 12, an “initial sheet number” is a sheet number used in the case where a read or write process is performed on all radio tags normally, i.e., a sheet number of the case where its maximum number is the minimum necessary number of sheets. In contrast, a “final sheet number” is a number of a finally necessary sheet as a result of adding a sheet to retry a process due to an error of a radio tag.

A flow of the processing result of FIG. 12 is as follows.

(1) As a result of sequentially executing jobs of job Nos. 1 and 2, an error occurred in write data (of which the write destination was the radio tag T3) of data No. 3 in job No. 1 (corresponding to initial sheet No. 1) and in data Nos. 7 and 8 (of which the write destinations were the radio tags T3 and T4) in job No. 2 (corresponding to initial sheet No. 2), and the other radio tags were processed normally.

(2) When the final job of job No. 3 was executed, because the radio tags T3 and T4 were free on the sheet in the job of job No. 3 (initial sheet No. 3), these were assigned to the write data of erroneous data Nos. 3, 7, and 8 in (1), and the job of job No. 3 was executed.

(3) As a result of (2), an error occurred in the write data of data No. 3 (of which the write destination was the radio tag T3) and the other radio tags were processed normally.

(4) A new sheet (final sheet No. 4) was added and the write data of data Nos. 3 and 8 that were not processed due to errors up to (3) was assigned to the radio tags T1 and T2 of the target sheet in the order in which the errors occurred. In the example of FIG. 12, because a second error occurred in the job of job No. 3 for the write data of data No. 3, the write data of data No. 8 was assigned to the radio tag T1 and the write data of data No. 3 was assigned to the radio tag T2.

At this time, the image forming device 10 changed the position information included in the write data in accordance with the position of the radio tag that was assigned. For example, in the example of FIG. 12, the position information of the write data of data No. 3 was changed from 3 (corresponding to the radio tag T3) to 2 (corresponding to the radio tag T2), the position information of the write data of data No. 7 was changed from 3 (corresponding to the radio tag T3) to 4 (corresponding to the radio tag T4), and the position information of the write data of data No. 8 was changed from 4 (corresponding to the radio tag T4) to 1 (corresponding to the radio tag T1).

(5) As a result of (4), the write data for both data Nos. 8 and 3 was processed normally and images were formed in the print areas of the corresponding sub-sheets according to the print data. Thereby, the processing of all print data was completed.

According to the flow of this process, even if an error occurs in some of the radio tags, the normal processing results can be effectively utilized. More specifically, in the conventional technology, when an error has occurred in some of the radio tags, because a retry process including the process for the radio tags that have been processed normally is performed on a separate sheet, a processing time may be lengthened. In contrast, according to the processing method of the embodiment, the radio tags that have been processed normally and the radio tags having errors are clearly distinguished from each other and provided to the user, such that the normal processing results can be effectively utilized, and the processing time can be prevented from becoming too long.

For example, according to the present embodiment, because image formation is performed only in the print area corresponding to the normal radio tag, the user can visually easily and reliably identify which sub-sheets are available. Moreover, because sheets that do not contain normal processing results are conveyed to a discharge destination different from that of sheets that contain normal processing results, the user can quickly and reliably determine which sheets can be discarded.

Moreover, in the conventional technology, a radio tag sheet in which an error occurred in some of the radio tags has been a disposal target even if the sheet includes normal radio tags. In contrast, according to the processing method of the embodiment, because the processing of the erroneous print data is performed on the sub-sheets that are free in the final job and subsequent sheets, the ineffectiveness of radio tags or radio tag sheets can be reduced and the deterioration in the overall processing efficiency can be suppressed.

According to at least one of the embodiments described above, when special paper for multi-tag having a plurality of RFID tags is processed, it is possible to suppress the deterioration in overall processing efficiency caused by defective RFID tags.

While several embodiments have been described, such embodiments are presented as examples and are not intended to limit the scope of the invention. These embodiments can be performed in other various forms, and various omissions, substitutions, and other modifications can be made without departing from the spirit or scope of the invention. Accordingly, these embodiments and the modifications thereof, similar to a case of being included in the scope or the concept of the invention, are included in the invention described in the claims and the scope of equivalency thereof.

What is claimed is:

1. An image forming device comprising:
an image former configured to form an image on a radio tag sheet that is a sheet having a plurality of radio tags;
a tag communicator configured to perform a write process of write data to the radio tags; and
a controller configured to perform image formation according to the write data in a target area according to the radio tag on the radio tag sheet in a case where no error has occurred in the write process,
wherein, in a case where an error has occurred in the write process, the controller is configured to perform a write process related to write data in which the error has occurred, to another radio tag sheet different from the radio tag sheet, and
wherein, in a case where a plurality of write data items are sequentially processed, if there is a space in a radio tag on a target sheet, which is a radio tag sheet on which a final write process is performed, and there is write data erroneous in the write process on a radio tag sheet before the target sheet, the controller is configured to execute the write process for the target sheet by including a part or all of the erroneous write data in a processing target.

2. The image forming device according to claim 1,
wherein the write data includes position information indicating a position of a radio tag of a write destination, and
wherein the controller is configured to change position information included in the write data in which the error has occurred to position information of a radio tag serving as a write destination in the another radio tag sheet.

3. The image forming device according to claim 2,
wherein the radio tag is configured to store in advance an identifier related to a position of the radio tag on the radio tag sheet, and
wherein the controller is configured to write the write data to the radio tag having the identifier corresponding to the position information included in the write data.

4. The image forming device according to claim 2, wherein the controller is configured to update the position information included in the write data in which the error has occurred to the position information indicating a different position.

5. The image forming device according to claim 1, wherein the controller is configured to execute the write process by including a part or all of the write data in which the write process is erroneous in the processing target in accordance with an order in which the error has occurred.

6. The image forming device according to claim 1, further comprising a storage configured to store unit data that is a combination of the write data and image forming data related to an image formed in image formation according to the write data,
wherein the controller is configured to perform image formation according to the image forming data associated with write data of a processing target, to the target area.

7. The image forming device according to claim 6, wherein the controller is configured to perform the image formation only to the target area according to the radio tag in which the error has not occurred in the write process.

8. The image forming device according to claim 1, wherein the controller is configured to determine that no error has occurred in the write process, in a case where reading of the write data from the radio tag after writing has succeeded after the write process of the write data was performed for the radio tag.

9. The image forming device according to claim 1,
wherein, in a case where there is no space for a radio tag on the target sheet, the controller is configured to perform the write process of the write data of which the write process is erroneous in the target sheet and the radio tag sheet before the target sheet, to another radio tag sheet different from the target sheet, and
wherein the controller is configured to perform a write process of write data that is not included in the processing target of the target sheet among write data of which the write process is erroneous in the radio tag sheet before the target sheet, to the another radio tag sheet different from the target sheet.

10. The image forming device according to claim 9, wherein the controller is configured to perform the write process of the write data of which the write process is erroneous in the target sheet, to the another radio tag sheet, in addition to the write process of the write data that is not included in the processing target of the target sheet.

11. The image forming device according to claim 9, wherein the controller is configured to execute the write process for the other radio tag sheet by including the write process of the write data that is not included in the processing target of the target sheet and the write data of which the write process is erroneous in the target sheet in the processing target in accordance with an order in which the error has occurred.

12. The image forming device according to claim 1, wherein the controller is configured to perform a write process related to write data in which an error has occurred to another radio tag sheet, in a case where an error has further occurred in the write process for the target sheet with including a part or all of the write data of which the write process is erroneous in the processing target.

13. The image forming device according to claim 1,
wherein the controller is configured to convey the radio tag sheet to a first discharge destination in a case where there is a radio tag to which the write data has been successfully written in the radio tag sheet, and
wherein the controller is configured to convey the radio tag sheet to a second discharge destination different from the first discharge destination in a case where there is no radio tag to which the write data has been successfully written in the radio tag sheet.

14. The image forming device according to claim 13,
wherein the radio tag is configured to store an identifier for identifying the radio tag in advance, and
wherein the controller is configured to read identifiers from the plurality of radio tags provided in the radio tag sheet, and convey the radio tag sheet to the second discharge destination in a case where any of the plurality of radio tags fails to be read.

15. The image forming device according to claim 1,
wherein the radio tag is configured to store in advance an identifier related to a position of the radio tag on the radio tag sheet, and
wherein the controller is configured to write write data according to the identifier read from the radio tag to the radio tag.

16. The image forming device according to claim 1,
wherein the radio tag is configured to store in advance an identifier related to a position of the radio tag on the radio tag sheet, and
wherein the tag communicator is configured to identify the position of the radio tag on the radio tag sheet on the basis of the identifier.

17. The image forming device according to claim 1, wherein the controller is configured to execute the write process for the target sheet by targeting only the write data erroneous in the write process among the plurality of write data items.

18. The image forming device according to claim 1, wherein the controller is configured to exclude the write data in which the error has not occurred in the write process among the plurality of write data items, from a target of the write process for the target sheet.

19. An image forming method comprising:
an image forming process in which an image forming device forms an image on a radio tag sheet that is a sheet having a plurality of radio tags;
a write process in which the image forming device writes write data to the radio tags; and
a control process in which the image forming device performs image formation according to the write data in a target area according to the radio tag on the radio tag sheet in a case where no error has occurred in the write process,
wherein the control process includes:
in a case where an error has occurred in the write process, performing a write process related to write data in which the error has occurred to another radio tag sheet different from the radio tag sheet, and
in a case where a plurality of write data items are sequentially processed, if there is a space in a radio tag on a target sheet, which is a radio tag sheet on which a final write process is performed, and there is write data erroneous in the write process on a radio tag sheet before the target sheet,
executing the write process for the target sheet by including a part or all of the erroneous write data in a processing target.

20. A non-transitory computer-readable recording medium storing a program for causing a computer of an image forming device, which performs an image forming process for forming an image on a radio tag sheet that is a sheet having a plurality of radio tags; a write process for writing write data to the radio tags; and a control process for performing image formation according to the write data in a target area according to the radio tag on the radio tag sheet in a case where no error has occurred in the write process, to execute processes of:
in a case where an error has occurred in the write process, performing a write process related to write data in which the error has occurred to another radio tag sheet different from the radio tag sheet in the control process, and
in a case where a plurality of write data items are sequentially processed, if there is a space in a radio tag on a target sheet, which is a radio tag sheet on which a final write process is performed, and there is write data erroneous in the write process on a radio tag sheet before the target sheet,
executing the write process for the target sheet in the control process by including a part or all of the erroneous write data in a processing target.
